(19) United States
(12) Patent Application Publication
(10) Pub. No.: US 2022/0309230 A1
(43) Pub. Date: Sep. 29, 2022

(54) BIDIRECTIONAL SEQUENCE GENERATION

(71) Applicant: NEC Laboratories Europe GmbH, Heidelberg (DE)

(72) Inventors: Carolin LAWRENCE, Heidelberg (DE); Bhushan KOTNIS, Heidelberg (DE); Mathias NIEPERT, Heidelberg (DE)

(21) Appl. No.: 17/610,460

(22) PCT Filed: Sep. 9, 2019
(86) PCT No.: PCT/EP2019/074007

§ 371 Date: Nov. 11, 2021

(30) Foreign Application Priority Data
May 14, 2019 (EP) 19174291.5

(51) Int. Cl. G06F 40/151; G06F 40/40; G06F 40/284; G06F 40/166; G06N 7/00

(52) U.S. Cl. CPC G06F 40/151; G06F 40/40; G06F 40/284; G06F 40/166; G06N 7/005

(57) ABSTRACT

A method for transforming an input sequence into an output sequence includes obtaining a data set of interest, the data set including input sequences and output sequences, wherein each of the sequences is decomposable into tokens. At a prediction time, the input sequence is concatenated with a sequence of placeholder tokens of a configured maximum length to generate a concatenated sequence. The concatenated sequence is provided as input to a transformer encoder that is learnt at a training time. A prediction strategy is applied to replace the placeholder tokens with real output tokens. The real output tokens are provided as the output sequence.

### CROSS REFERENCE TO RELATED APPLICATION

This application is a U.S. National Phase application under 35 U.S.C. § 371 of International Application No. PCT/EP2019/074007, filed on Sep. 9, 2019, and claims benefit to European Patent Application No. EP 19174291.5, filed on May 14, 2019. The International Application was published in English on Nov. 19, 2020, as WO 2020/228969 A1 under PCT Article 21(2).

### FIELD

The present invention relates to a computer-implemented method and a processing system for transforming an input sequence into an output sequence.

### BACKGROUND

Sequence data is ubiquitous and occurs in numerous application domains. Examples are sentences and documents in natural language processing (NLP) and request traffic in a data or communication network. The objective of machine learning approaches in these systems, like e.g. dialog systems, summarization or information extraction, is to either classify sequences or to transform one sequence into another. The invention is addressing the latter problem which occurs in various application domains ranging from machine translation to transforming language instructions to sequences of machine commands.

Sequence-to-sequence neural models typically follow an encoder-decoder approach: First, the encoder converts an input sequence into an intermediate representation of real valued vectors. Second, given this representation, a decoder produces an output sequence token-by-token from left-to-right. As a result, the decoder can only take tokens into considerations that have been produced already.

The encoder on the other hand is not restricted in such a manner, as the sequence to be encoded is known in its entirety a priori. As a result, it is common practice when employing Recurrent Neural Networks (RNNs) to process the input both from left-to-right and right-to-left before finally combining both representations, e.g. by concatenation. However, ultimately RNNs are still restricted to sequential orderings, which makes the handling of long-range dependencies difficult.

To alleviate this issue, Vaswani et al., 2017 first introduced the concept of self-attention, where an input is treated as a fully connected graph rather than a sequence (cf. A. Vaswani et al.: “Attention is all you need”, 31^{st} Conference on Neural Information Processing Systems (NIPS 2017), Long Beach, Calif., USA, 2017). This allows the input to be encoded in a bidirectional manner, where each token considers every other token when computing this token's representation. This concept of bidirectional self-attention is also applied in the decoder by Vaswani et al., 2017, however only over the set of tokens that have been produced so far.

### SUMMARY

In an embodiment, the present disclosure provides a method for transforming an input sequence into an output sequence. A data set of interest that includes input sequences and output sequences is obtained. Each of the sequences is decomposable into tokens. At a prediction time, the input sequence is concatenated with a sequence of placeholder tokens of a configured maximum length to generate a concatenated sequence. The concatenated sequence is provided as input to a transformer encoder that is learnt at a training time. A prediction strategy is applied to replace the placeholder tokens with real output tokens. The real output tokens are provided as the output sequence.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic view illustrating an encoder-decoder approach according to an embodiment of the invention,

FIG. 2 is a schematic view illustrating a self-attention concept applied in connection with embodiments of the invention, and

FIG. 3 is a functional overview illustrating an overall process at training time (left part) and at prediction time (right part) in accordance with an embodiment of the invention.

### DETAILED DESCRIPTION

Embodiments of the present invention improve and further develop a method and a system of the initially described type in such a way that true bidirectionality at decoding time is achieved, where even future, not-yet-produced tokens can be taken into consideration.

In accordance with an embodiment of the invention, these improvements are provided by a method for transforming an input sequence into an output sequence, the method comprising:

obtaining a data set of interest, the data set including input sequences and output sequences, wherein each of the sequences is decomposable into tokens,

at a prediction time, concatenating an input sequence with a sequence of placeholder tokens of a configured maximum length to generate a concatenated sequence,

giving the concatenated sequence as input to a transformer encoder that is learnt at a training time,

applying a prediction strategy to replace the placeholder tokens with real output tokens, and

providing the real output tokens as output sequence.

In accordance with another embodiment of the invention, the aforementioned improvements are provided by a processing system for transforming an input sequence into an output sequence, the system comprising one or more processors configured to:

obtain a data set of interest, the data set including input sequences and output sequences, wherein each of the sequences is decomposable into tokens,

at a prediction time, concatenate an input sequence with a sequence of placeholder tokens of a configured maximum length to generate a concatenated sequence,

give the concatenated sequence as input to a transformer encoder that is learnt at a training time,

apply a prediction strategy to replace the placeholder tokens with real output tokens, and

provide the real output tokens as output sequence.

According to embodiments of the invention it has been recognized that, while generating a word in natural language, it is advantageous to take not just past but also future tokens into account. To introduce true bidirectionality at decoding time, where even future, not-yet-produced tokens can be taken into consideration, embodiments of the invention modify a transformer encoder to handle both input and output simultaneously. According to embodiments, the encoder starts out with placeholders tokens on the output side and subsequently replaces these with tokens from the output vocabulary. This can be done in an arbitrary order, i.e. generation is no longer restricted to be performed from left to right. Furthermore, it is possible to take not-yet-produced tokens into account via a self-attention mechanism calculated by the transformer encoder for each token of the concatenated sequence with regards to every token of the concatenated sequence.

Embodiments of the invention also aim to address the above problem by using a fully connected graph that can take past and future tokens into account via placeholder tokens. Jointly these two elements provide significant performance improvements. In particular, the output sequence can be generated in an arbitrary order.

In general, embodiments of the invention are not restricted to NLP problems, but can be applied to any sequence generation task.

According to embodiments of the invention, regarding sequence generation with the transformer encoder it may be provided that a transformer encoder model is used to generate new texts using placeholder tokens during prediction time. The input sequence and the output sequence are concatenated to perform sequence generation where input sequence and output sequence can be treated as joint/one fully connected graph before the output sequence generation begins. Consequently, when generating the output, not only previously generated tokens, but also not yet produced terms can be taken into account.

According to embodiments of the invention, it may be provided that during training the process of replacing tokens of the gold output sequence with placeholder tokens (which is termed as the placeholder strategy, by which the model is trained) is executed either by means of a list-based sampling, by means of a Gaussian probability distribution sampling, or by means of a classifier trained via reinforcement learning.

According to embodiments of the invention, regarding the configuration of the prediction strategy it may be provided that either all placeholder tokens are replaced at once, placeholder tokens are replaced iteratively, choosing the position with lowest entropy, or placeholder tokens are replaced iteratively going from left to right. In any case, prediction is stopped once the end-of-sequence token has been produced or the maximum sequence length (set a priori) is reached.

According to embodiments of the present invention relates to a method for transforming an input sequence into an output sequence comprising the steps of obtaining data of interest with both input and output sequences, wherein each sequence can be decomposed into tokens and of implementing a placeholder strategy which decides which tokens in an output sequence to replace with a placeholder token.

At a training time, a data point of interest is obtained and the following steps may be performed: concatenate input and output sequence, give the concatenation to the placeholder strategy to obtain a training sequence, and handing over the training sequence to a transformer encoder. It may be provided that the parameters of the transformer encoder are updated to increase the probability of the correct output token for the corresponding placeholder token. Next, a prediction strategy may be implemented which decides how many placeholder tokens to replace, which ones and with which output vocabulary tokens.

At a prediction time, for a given input sequence, the following steps may be executed: concatenate the input sequence with a sequence of placeholder tokens of some maximum sequence length, give the concatenation to the transformer encoder learnt at the training time, use the prediction strategy to iteratively replace placeholder tokens with real output tokens, and stop prediction once the end-of-sequence token has been generated. Finally, the different training and prediction strategies may be tested to choose the best model on held-out data.

NLP systems like, e.g., dialog systems, summarization or information extraction require understanding previous context as well as planning a good response in this context. Embodiments of the present invention relate to methods and systems that use a fully connected graph to better accomplish this task. These methods and systems are configured to take both past and future, not-yet-produced tokens into consideration such that the output sequence can be generated in an arbitrary order.

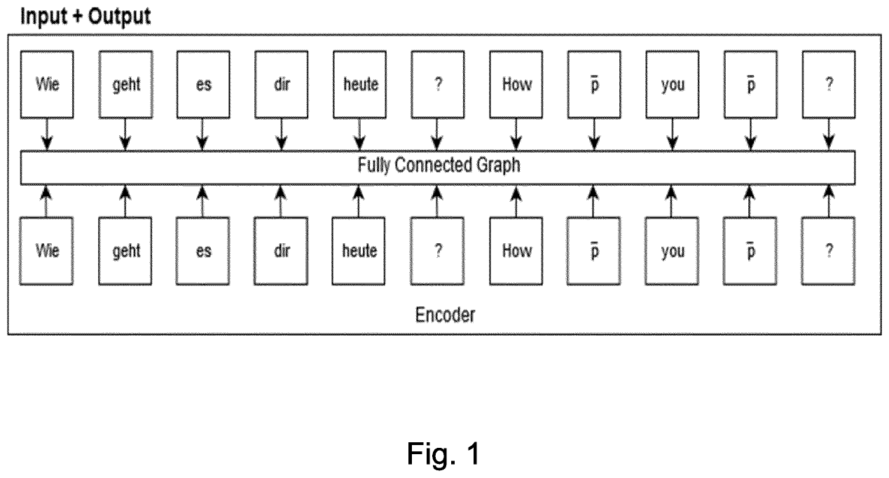

In the example shown in FIG. 1, both the input sequence (i.e. the boxes until and including the question mark) and the output sequence (i.e. the boxes after the question mark) are modelled as a fully connected graph. The output sequence can be generated in arbitrary order and future tokens can be taken into account. E.g. for the missing word in the second output position p̅, it can both take the future tokens “you” and “?” as well as the other future p̅ into consideration when choosing a word for the second output position p̅.

The present invention particularly applies to sequence-to-sequence tasks. In this context one can assume a given input sequence x that decomposes over individual tokens, i.e. x=x₁, x₂, . . . , x_{|x|}, where each token xᵢ ∈ x is a token from an input vocabulary X. In this case, the goal is to learn a mapping of x to an output sequence y that similarly decomposes over tokens, i.e. y=y₁, y₂, . . . , y_{|y|}, where each token yᵢ ∈ y is a token from an input vocabulary Y.

At training time, embodiments of the invention assume supervised data, where each data point x is associated with a gold output sequence y. However, at prediction time, y is unknown. Thus, according to embodiments of the invention, each token yᵢ is replaced with a placeholder token p̅. To incorporate this notion at training time, a placeholder strategy is introduced where some tokens yᵢ are replaced with the placeholder token p̅ at training time. This means the sequence y is replaced by sequence p=p₁, p₂, . . . , p_{|p|}, where a token pⱼ is either the original token yⱼ or the placeholder token p̅.

For the placeholder strategy, different implementations are possible. In all cases, it may be provided that placeholders are allocated anew after every epoch. Replacing all tokens with the placeholder token is not feasible because it leads to inferior performance. Instead, any of the following embodiments may be implemented:

According to a first approach a list-based sampling may be applied, where a random sample t is drawn from a list of percentages, each list item is a value in the range [0, 1]. For each token in yⱼ, a value u in the range [0, 1] may be sampled. It may be provided that if u<t, then yⱼ is replaced by p̅.

According to a second approach a Gaussian probability distribution sampling may be applied. According to this approach the number of placeholders is varied on a per-example basis. For each example, a value is sampled from a Gaussian distribution with a separate set mean and standard deviation. The sampled value determines the percentage of placeholder tokens in the current example. Which tokens are replaced can be determined in various ways, e.g. (i) randomly, (ii) by highest probability, or (iii) by lowest entropy.

The third approach is based on reinforcement learning. Specifically, reinforcement learning is used to train a classifier which determines for each position whether to use a placeholder token or the original token. The procedure may be implemented in such a way that first the classifier produces a probability distribution μ of dimension 2 for each position, where one dimension is the probability to keep the original token yⱼ and the other the probability to use the placeholder token p̅. Next, a decision is made whether to keep the original token yⱼ or use the placeholder token p̅. Possible options include (i) to choose the most likely class from the probability distribution μ, (ii) to sample from the probability distribution or (iii) an ‘ε-greedy’ approach that chooses a random class from the probability distribution μ with probability ε, and that chooses the most likely class from the probability distribution μ with probability 1−ε. Then, for each token pⱼ in p a reward rⱼ is assigned, leading to a reward sequence r=r₁, r₂, . . . , r_{|p|}. Finally, the classifier may be updated based on the chosen sequence p and associated reward r.

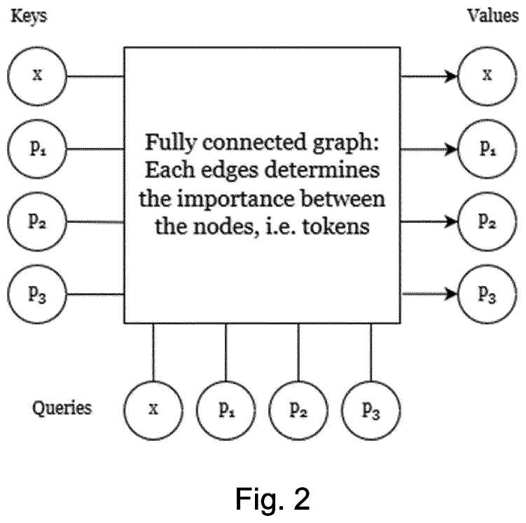

According to an embodiment, given x and p, these two sequences are concatenated to generate a concatenated sequence s, i.e. s=x+p. Next, the sequence s is given to a transformer encoder, as described in A. Vaswani et al.: “Attention is all you need”, 31^{st} Conference on Neural Information Processing Systems (NIPS 2017), Long Beach, Calif., USA, 2017, which in its entirety is incorporated herein by reference. The transformer encoder calculates self-attention probabilities for each token in s with regard to every token in s, i.e. it produces a fully connected graph between “Queries” and “Keys”, as shown in FIG. 2. In this fully connected graph edge weights determine the importance between the two nodes/tokens. Then the representation of each token is updated with regard to the self-attention probabilities calculated by the transformer encoder (see “Values” of FIG. 2). Advantageously, since the entire sequence is already present, future as well as past tokens can be taken into consideration when generating an output token.

Based on the values resulting from the self-attention process, for every token pⱼ, the transformer encoder produces a probability distribution dⱼ over the output vocabulary. Training may be performed in a supervised manner using maximum likelihood estimation where the probability of producing the gold tokens yⱼ is increased for the corresponding token pⱼ.

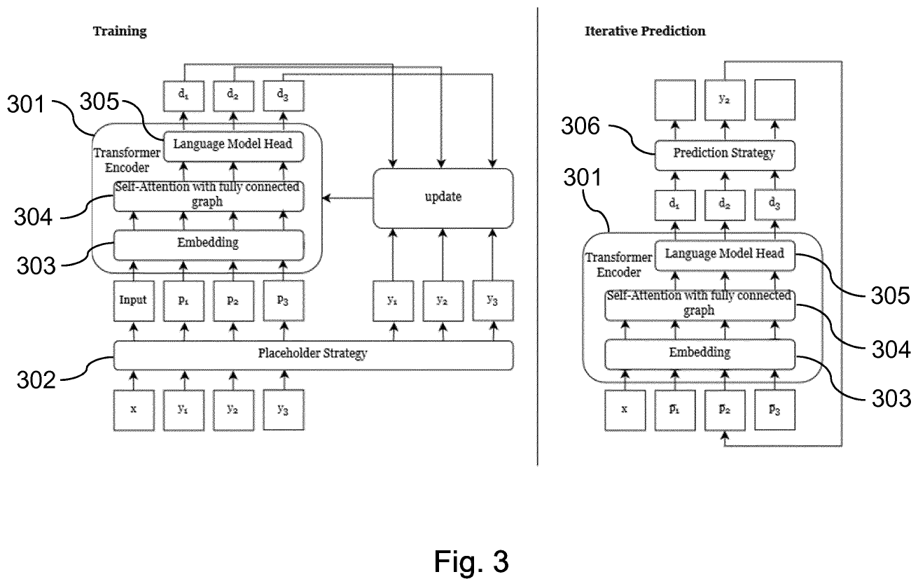

FIG. 3, left part, schematically illustrates the overall process at training time according to an embodiment of the present invention. Specifically, at training time, the input sequence x (depicted by the box labelled ‘x’ in FIG. 3) is concatenated with the gold output sequence y (depicted by the boxes labelled ‘y₁’, ‘y₂’ and ‘y₃’ below placeholder strategy module 302). Next, the placeholder strategy implemented within placeholder strategy module 302 sets up the placeholder sequence where some tokens of the gold output sequence y are replaced by placeholder tokens (depicted by the boxes labelled ‘p₁’, ‘p₂’ and ‘p₃’). The input sequence is passed through without any changes (depicted by the box labelled ‘Input’). The sequence is given to a transformer encoder 301 which first embeds the sequence (depicted by the boxes labelled ‘Input’, ‘p₁’, ‘p₂’ and ‘p₃’) by means of embedding module 303, then applies a ‘Self-Attention with fully connected graph’ module 304 where a self-attention probability matrix of all tokens over all other tokens is produced. Finally, a ‘Language Model Head’ module 305 of transformer encoder 301 produces for each placeholder token a probability distribution over an output vocabulary (depicted by the boxes labelled ‘d1’, ‘d2’ and ‘d3’). Using maximum likelihood estimation, the gold token's probabilities (depicted by the boxes labelled ‘y1’, ‘y2’, ‘y3’ above the placeholder strategy module 302 are raised (depicted by box labelled ‘update’).

At prediction time, the input x is concatenated with a sequence of placeholder tokens, i.e. p=p̅₁, p̅₂, . . . , p̅_{|p|}, where |p| is a previously, i.e. a priori set maximum possible sequence length. Iteratively, the placeholder tokens are replaced with tokens of the output vocabulary Y. With respect to a specific implementation of the prediction strategy, a number of key points have to be considered. For instance, it has to be determined how many placeholder tokens should be replaced. In this regard, according to a first approaches it may be provided that are replaced in one single step. Alternatively, an iterative process could be implemented in which, e.g., one placeholder is replaced token at a time.

According to another aspect it has to be determined which placeholder tokens should be replaced. For instance, according to a first approach it may be provided to replace the placeholder token with the overall lowest entropy for a token in the output vocabulary. Alternatively, it may be provided to replace the left most placeholder token, which would lead to producing a sequence from left to right.

According to still another aspect it has to be determined which token of the output vocabulary should be chosen. According to the first approach it may be provided to choose the most likely token in the output vocabulary. Alternatively, it may be provided to choose a sample from the probability distribution over the output vocabulary.

FIG. 3, right part, schematically illustrates the overall process at prediction time according to an embodiment of the present invention. Specifically, at prediction time, the input sequence (depicted by the box labelled ‘x’) is concatenated with a sequence of placeholder tokens of some maximum length (depicted by the boxes labelled ‘p̅1’, ‘p̅2’ and ‘p̅3’). Passed through the transformer encoder 301 (which follows the same path as described above for the procedure at training time depicted in the left part of FIG. 3), a probability distribution over the output vocabulary is obtained for every placeholder token (depicted by the boxes labelled ‘d1’, ‘d2’ and ‘d3’). According to the illustrated embodiment, the prediction strategy implemented within the predication strategy module 306 iteratively replaces placeholder tokens with tokens from the output vocabulary. In the illustrated embodiment, the prediction strategy replaced the second placeholder token with the output token ‘y2’ as depicted by the box ‘y2’. The output tokens that were selected at one time step are used instead of the placeholder token at the next time step (i.e. in the next time step, ‘p̅2’ will become ‘y2’.

With the method according to the embodiment described above in place, it is possible to generate a sequence bidirectionally. Thus, when deciding on an output token, all other tokens can be taking into consideration. This includes past and future tokens and produced or not-yet-produced tokens. Furthermore, the sequence generation does not have to be performed from left to right.

As an empirical evidence, the success of the bidirectional sequence generation approach in accordance with embodiments of the invention is demonstrated on two dialogue generation tasks for conversational AI. First, the task-oriented data set ShARC was employed, where the system needs to understand complex regulatory texts in order to converse with a user to determine how the user's specific situation applies to the given text. Second, experiments were conducted on the free-form, chatbot-style data set Daily Dialog.

With a method of bidirectional sequence generation according to embodiments of the invention in place, it is furthermore possible to directly leverage the pre-trained language model BERT (cf. Jacob Devlin et al.: “BERT: Pre-training of Deep Bidirectional Transformers for Language Understanding”, in Proceedings of NAACL-HLT 2019, Minneapolis, Minn., Jun. 2-Jun. 7, 2019, pages 4171-4186, https://www.aclweb.org/anthology/N19-1423, which is incorporated herein by reference) as it is also based on an transformer encoder. Both methods in conjunction can outperform the previous state-of-the-art as well as other competitive baselines on both datasets.

In the context of the above mentioned bidirectional language model called BERT (Bidirectional Encoder Representations from Transformers) it is important to note that, once pre-trained on abundant monolingual, non-task specific data, Devlin et al., 2019 showed that it is easily possible to fine-tune the model for various classification tasks. Their model outperforms other fine-tuned language models that processed data either sequentially or non-bidirectionally. For NLP tasks, embodiments of the present invention directly incorporate this pre-trained bidirectional language model BERT as they are both based on a transformer encoder. Empirically, coupling a method according to embodiments of the invention with the pre-trained language model achieves new state-of-the-art results on two NLP datasets for dialogue response generation.

A model according to the present invention was initialized with the pre-trained language model BERT and has about 110M parameters. Three different placeholder strategies have been implemented, which concretely were instantiated in the following ways:

Model-1 (denoted BiSon-1 in Tables 1 and 2 below): List-based sampling:

A random sample t is drawn from the set {0.15, 0.3, 0.45, 0.6, 0.75, 0.90, 1}. For each token in yⱼ, a value u is sampled in the range [0, 1]. If u<t, then yⱼ is replaced by p̅.

Model-2 (denoted BiSon-2 in Tables 1 and 2): Gaussian probability distribution sampling:

From a set of means and a set of variances, the best combination is determined in an experiment via grid search. Placeholder tokens are allocated randomly.

Model-3 (denoted BiSon-3 in Tables 1 and 2): Classifier trained via reinforcement learning:

According to this model a separate classifier is trained that predicts, for each position, whether it should be a placeholder token or the original token. The classifier is trained via reinforcement learning where the reward function is based upon the probabilities assigned to the original token by the transformer encoder.

For the iterative prediction the following configurations were tested, and the best combination should be chosen as part of a tuning step:

1. All tokens are replaced (cf. “one step greedy” in Table 3 below) in one time step by choosing the most likely output token.

2. At each time step, one placeholder is replaced with the most likely token from the output vocabulary. Two different possibilities were tested, including a replacement of the position with lowest entropy (cf. “lowest entropy” in Table 3 below) and, alternatively, a replacement of the left most placeholder, leading to a prediction from left to right (cf. “left-to-right” in Table 3 below)

Three competitive baselines have been defined, which include the following:

1. Encoder-Decoder Transformer (E&D):

Here, the established bidirectional encoder model according to embodiments of the present invention is compared to a standard encoder-decoder transformer where the decoder only has access to tokens produced so far to compute its self-attention. In this prior art setup, the input is encoded in isolation before being fed into the decoder, whereas in the setup in accordance with the invention the self-attention is computed over the input and all possible output positions simultaneously. It is ensured that the prior art setup has the same model capacity as the proposed model. Needing both an encoder and a decoder, this leads to a total of about 270M parameters.

2. Encoder-Decoder Transformer with BERT (T+B):

The power of the bidirectional decoder according to embodiments of the invention stems from two advantages. First, the proposed model can be initialized with the pre-trained language model BERT. Second, the decoding process is bidirectional. It would be possible to transfer the first advantage to an encoder-decoder framework by using BERT embeddings. This is however only possible for the input sequence, because the bidirectionality of BERT requires the entire sequence to be available a priori. In an encoder-decoder framework the decoder produces one output token at a time and it is not possible to compute BERT embeddings. Thus, only the encoder is replaced by the BERT model. The weights of the encoder are frozen when training the decoder, which produced better results than allowing the gradients to also flow through the BERT model. Again, with both an encoder and decoder, this leads to a total of about 270M parameters.

3. GPT2 (Radford et al., 2019):

GPT2, as described in Alec Radford et al.: “Improving Language Understanding by Generative Pre-Training”, Technical Report Technical report, OpenAI, 2018) is a transformer decoder trained as a language model on large amounts of monolingual text. Radford et al. showed that it is possible to perform various tasks in a zero-shot setting by priming the language model with an input and letting it generate further words greedily. This setup can be transferred to a supervised setting, where the model is fine-tuned to a dataset by using maximum likelihood estimation to increase the probability of the gold output sequence. As the starting point for the supervised learning, the present model in accordance with embodiments of the invention is initialized with the pre-trained model GPT-2-117M3. With 117M parameters, this model is comparable to the present model. Unlike baseline 2, this setup can directly employ a pre-trained model as the present approach can, but it is not bidirectional.

The results of the performed tests were measured using BLEU n-gram scores which measures a modified precision for n-grams of length 1 through 4 by comparing the n-grams of a gold output sequence to the output sequence predicted by a model. A sentence can be split into its n-grams by moving a sliding window of size n across its tokens.

Additionally, for the ShARC dataset micro and macro accuracy were measured. In the ShARC dataset, gold output sequences are either a clarification question or a final answer in the set {“Yes”, “No”, “Irrelevant”}. By converting all clarification questions to a fourth category, “More”, a classification task has been created for which micro and macro accuracy can be measured.

Additionally, for the Daily Dialog data set, the overall BLEU score is reported. This overall BLEU score includes a brevity penalty, which punishes the model when model outputs are shorter than gold responses.

Additionally, for the Daily Dialog data set, the previous state-of-the-art results are reported for both information retrieval-based methods (IR SOTA) and end-to-end methods (E2E SOTA). This is not possible on the ShARC dataset as the test set reported in previous work is not available to the public and an own split had to be created.

Hyperparameters, i.e. the number of epochs and learning rate, were tuned on a held-out development set. The best model was picked according to BLEU 4-gram score. Results in Tables 1 and 2 below, for ShARc and Daily Dialog, respectively, are reported on a held-out test set for the different placeholder strategies BiSon-1, BiSon-2 and Bison-3 using the iterative left-to-right prediction strategies. Other prediction strategies for the placeholder strategy BiSon-2 are reported in Table 3 for both datasets.

TABLE 1
Results on the ShARC test (averaged over 3 independent runs for
GPT2 and BiSon-1/2/3), reporting micro accuracy and macro accuracy
in terms of the classification task and BLEU-1 and BLEU-4 on instances
for which a clarification question was generated.

Model

| Devtest | Micro Acc. | Macro Acc. | B-1 | B-4 |
|---|---|---|---|---|
| E&D | 36.0 | 46.9 | 7.2 | 0.6 |
| E&D + B | 61.9 | 67.4 | 26.8 | 3.1 |
| GPT2 | 75.8 | 78.9 | 61.1 | 44.9 |
| BISON-1 | 82.7 | 84.9 | 66.6 | 50.3 |
| BISON-2 | 82.7 | 84.7 | 63.4 | 48.9 |
| BISON-3 | 81.2 | 82.7 | 59.0 | 43.4 |

TABLE 2
Overall BLEU score (including the brevity penalty BP, higher is better),
BLEU-1 and BLEU-4 on the test set of the DailyDialog dataset (averaged
over 3 independent runs for GPT2 and BiSon-1/2/3).

| Model | B | BP | B-1 | B-4 |
|---|---|---|---|---|
| IR | — | — | — | 19.4 |
| E2E | — | — | 14.2 | 2.8 |
| E&D | 7.5 | 0.7 | 22.3 | 5.2 |
| E&D + B | 5.2 | 0.4 | 26.1 | 5.5 |
| GPT2 | 12.1 | 0.6 | 42.3 | 19.4 |
| BISON-1 | 12.6 | 0.5 | 55.0 | 26.1 |
| BISON-2 | 12.5 | 0.4 | 54.9 | 25.6 |
| BISON-3 | 19.6 | 0.8 | 41.5 | 16.0 |

TABLE 3
BLEU-4 using various sequence generation strategies
for BISON-2 on both datasets, ShARC and Daily Dialog.

| Strategy | ShARC | Daily Dialog |
|---|---|---|
| one step greedy | 30.0 | 9.3 |
| lowest entropy | 51.7 | 16.8 |
| left-to-right | 49.5 | 23.8 |

Embodiments of the present invention can be applied in various contexts. Hereinafter, some of the most important application scenarios will be described in some more details. As will be appreciated by those skilled in the art, further applications are possible.

1. Task-Oriented Text-Based Question-Answering (QA) Using Natural Dialogue:

Free-form Dialogue: x is the sequence of previously uttered tokens of a user and the system and y is the next response of the system.

This application is highly relevant for QA dialogue systems. Such QA dialogue systems can be implemented in many websites and apps which provide technical support for products and services. Customer and clients who encounter difficulties or have questions on the products and services would be able to interact with the QA system using natural language dialogue. For example, a financial institution can use a dialogue-based question answering system for answering frequently asked questions by customers. Embodiments of the proposed invention may be implemented to automatically generate relevant answers for customer questions from specified domains as a natural dialogue.

### Example

Customer: “I am a non-EU resident, can I open a security trading account at your bank?”

QA-Chatbot: “Yes, you can open a security trading account with us. We are happy to help you with the account opening”.

2. Summarization/Simplification in Municipal Services:

x is the sequence of sentences that should be summarized, whereas y is the summarization.

Embodiments of the invention may be implemented to summarize or simplify longer texts. This could be helpful in applications where humans would otherwise have to read the longer text to determine if the text is relevant or not, e.g. when trying to identify relevant passages in complex rule texts or manuals. Reading the summarization would speed-up the process and require less human effort. Alternatively, a simplified representation of a text could help non-native speakers to better understand complex texts.

3. Machine Translation in Municipal Services:

x is the sequence of tokens in the source language and y is the sequence of tokens in the target language.

Embodiments of the invention may be implemented to generate automated translations from one language to another. Municipal services can use such embodiments to automatically generate translation of useful information, periodic notices, frequently asked questions to other languages that are accessible by immigrants and tourists.

4. Human-Machine Interaction:

x is the sequence of tokens spoke or written by a human and y is a sequence of actions performed by the machine.

Embodiments of the invention may be implemented in human-machine interaction scenarios, where a human gives a spoken or written natural language instruction to an intelligent machine. The machine then needs to select the correct sequence of actions based on understanding the natural language instruction.

5. Time Series-Based Machine Actions:

x is a time series of relevant input features and y is a sequence of actions performed by the machine.

Embodiments of the invention may be implemented to be used for machines which receive a time series as input and have to react accordingly by performing a series of actions. One possible application could be intelligent buildings which react to changing weather circumstances by, for example, closing shutters on the building to shield from sunlight and reduce the building's temperature.

The embodiments of the invention can be applied to dialogue systems to generate better response as in previous systems. For instance, a specific use case could be free-format administrative manuals written by one company department, where a system according to the present invention automatically answers questions on the manual posed by, e.g., members of other company departments. In this context it would also be possible to achieve improvements with respect to chatbot systems.

Furthermore, embodiments of the present invention can be applied in connection with question-answering from, e.g. government-issued text, in order to simplify various procedures, and/or in connection with information extraction and link prediction. For instance, a method in accordance with the invention could be used to generate triples from news articles, such as “ship deployed_to location”. The input would be sentences of relevant news articles and the output would be triples. Alternatively, the news articles could be summarized, where inputs are relevant news articles and the output is a short summary.

Many modifications and other embodiments of the invention set forth herein will come to mind to the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for transforming an input sequence into an output sequence, the method comprising:
obtaining a data set of interest, the data set including input sequences and output sequences, wherein each of the sequences is decomposable into tokens,
at a prediction time, concatenating the input sequence with a sequence of placeholder tokens of a configured maximum length to generate a concatenated sequence,
providing the concatenated sequence as input to a transformer encoder that is learnt at a training time,
applying a prediction strategy to replace the placeholder tokens with real output tokens, and
providing the real output tokens as the output sequence.

2. The method according to claim 1, wherein the input sequences and output sequences are concatenated as a fully connected graph.

3. The method according to claim 1, wherein the transformer encoder calculates self-attention values for each token of the concatenated sequence with regards to every token of the concatenated sequence.

4. The method according to claim 3, wherein the transformer encoder generates, based on the calculated self-attention values, a probability distribution over an output vocabulary for each of the placeholder tokens.

5. The method according to claim 1, further comprising learning the transformer encoder at the training time by:
concatenating the input sequence with a gold output sequence, and
replacing, according to a placeholder strategy, tokens of the gold output sequence by placeholder tokens to generate a training sequence.

6. The method according to claim 5, wherein learning the transformer encoder at the training time further comprises:
providing the training sequence to the transformer encoder, and
calculating, by the transformer encoder, a self-attention probability matrix of all tokens of the training sequence over all other tokens of the training sequence.

7. The method according to claim 6, wherein learning the transformer encoder at the training time further comprises:
using, by the transformer encoder, maximum likelihood estimations to increase a probability of obtaining a correct output token for a corresponding placeholder token of the gold output sequence.

8. The method according to claim 5, wherein applying the placeholder strategy to replace the tokens of the gold output sequence by the placeholder tokens comprises a list-based sampling including the steps of:
creating a random sample t from a list of percentages, each list item being a value in the range [0, 1],
sampling, for each token of the gold output sequence, a value u in the range [0, 1], and
replacing the respective token by a placeholder token in a case that the value u<t.

9. The method according to claim 5, wherein applying the placeholder strategy to replace the tokens of the gold output sequence by the placeholder tokens comprises a Gaussian probability distribution sampling including the steps of:
for each example, sampling a value from a Gaussian distribution, wherein the sampled value determines a percentage of the placeholder tokens in the respective example, and
determining randomly, by highest probability or by lowest entropy which specific tokens are replaced.

10. The method according to claim 5, wherein applying the placeholder strategy to replace the tokens of the gold output sequence by the placeholder tokens comprises using reinforcement learning techniques to train a classifier which determines for each position of the gold output sequence whether to replace an original token by one of the placeholder tokens or whether to keep the original token.

11. The method according to claim 1, wherein applying the prediction strategy comprises:
iteratively replacing the placeholder tokens with tokens from an output vocabulary, and
using tokens replaced at one time step of iteration instead of the respective placeholder tokens at a next time step of iteration.

12. The method according to claim 11, wherein the iterative replacement of the placeholder tokens is performed either by going through the output sequence from left to right or by choosing in each time step of iteration the position of the output sequence with the lowest entropy.

13. The method according to claim 1, wherein, for natural language processing (NLP) tasks, the transformer encoder is learned at the training time by directly incorporating a pre-trained bidirectional language model Bidirectional Encoder Representations from Transformers (BERT).

14. A processing system for transforming an input sequence into an output sequence, the system comprising one or more processors configured to:
obtain a data set of interest, the data set including input sequences and output sequences, wherein each of the sequences is decomposable into tokens,
at a prediction time, concatenate the input sequence with a sequence of placeholder tokens of a configured maximum length to generate a concatenated sequence,
provide the concatenated sequence as input to a transformer encoder that is learnt at a training time,
apply a prediction strategy to replace the placeholder tokens with real output tokens, and
provide the real output tokens as the output sequence.

15. A non-transitory computer-readable medium comprising code for causing one or more processors of a processing system to:
obtain a data set of interest, the data set including input sequences and output sequences, wherein each of the sequences is decomposable into tokens,
at a prediction time, concatenate an input sequence with a sequence of placeholder tokens of a configured maximum length to generate a concatenated sequence,
provide the concatenated sequence as input to a transformer encoder that is learnt at a training time,
apply a prediction strategy to replace the placeholder tokens with real output tokens, and
provide the real output tokens as an output sequence.
